(19) United States
(12) Patent Application Publication
(10) Pub. No.: US 2006/0220783 A1
(43) Pub. Date: Oct. 5, 2006

(54) Mounting structure of double-path chip resistor

(75) Inventor: Takahiro Kuriyama, Kyoto-shi (JP)

Correspondence Address: HAMRE, SCHUMANN, MUELLER & LARSON, P.C., P.O. BOX 2902-0902, MINNEAPOLIS, MN, 55402, US

(73) Assignee: ROHM CO., LTD., Kyoto-shi (JP)

(21) Appl. No.: 11/392,364

(22) Filed: Mar. 29, 2006

(30) Foreign Application Priority Data
Mar. 30, 2005 (JP) 2005-098576

(51) Int. Cl. H01C 1/012

(52) U.S. Cl. 338/307

(57) ABSTRACT

A mounting structure includes a printed circuit board and a dual-element chip resistor fixed to the circuit board. The chip resistor includes a rectangular insulating substrate and two resistor elements arranged in parallel to each other on the circuit board. Each resistor element includes an elongated resistor film formed on the substrate and two terminal electrodes at respective ends of the resistor film. The circuit board has a surface provided with at least four land patterns disposed with a predetermined pitch. The chip resistor is soldered to adjacent two of these four land patterns. The substrate of the chip resistor includes an edge extending in a direction in which the two resistor elements are spaced away from each other, and the edge of the substrate has a length which is smaller than double the pitch interval of the land patterns.

### BACKGROUND OF THE INVENTION

1. Field of the Invention

The present invention relates to a chip resistor of dual-path or dual-element type that comprises a single rectangular insulating substrate, two parallel-arranged resistor elements each made of a resistor film formed on the substrate, and terminal electrodes at the both ends of the substrate. In particular, the present invention relates to a mounting structure for mounting and soldering such a dual-path-chip resistor on a printed circuit board.

2. Description of the Related Art

Widely known chip resistors include a chip resistor comprising one resistor element (hereinafter, referred to as “single-element chip resistor”) A1 as shown in FIG. 1, a chip resistor comprising two resistor elements (hereinafter, referred to as “dual-element chip resistor”) A2 as shown in FIG. 2, and a chip resistor comprising four resistor elements (hereinafter, referred to as “quad-element chip resistor”) A4 as shown in FIG. 3.

A single-element chip resistor A1 comprises a rectangular insulating substrate 1 and a resistor element 4 which is made of a resistor film 2 and terminal electrodes 3 at the both ends of the substrate. A dual-element chip resistor A2 comprises a rectangular insulating substrate 1′ and two parallel-arranged resistor elements 4′ each of which is made of a resistor film 2′ and terminal electrodes 3′ at the both ends of the substrate. A quad-element chip resistor A4 comprises a rectangular insulating substrate 1″ and four parallel-arranged resistor elements 4″ each of which is made of a resistor film 2″ and terminal electrodes 3″ at the both ends of the substrate.

Each of above-described kinds of chip resistors is available in several standard sizes such as 0603 size, 1005 size, as is generally known.

In order to provide a single-element chip resistor A1 compliant with 0603 size standard, dimensions of the insulating substrate 1 are determined as follows. The dimension L1 should be 0.3 mm, which is the length of an edge containing a terminal electrode 3. The dimension W1 should be 0.6 mm, which is the length of an edge perpendicular to the above-mentioned edge.

In order to provide a dual-element chip resistor A2 compliant with 0603 size standard, dimensions of the insulating substrate 1′ are required to be determined as follows. The dimension L2 should be 0.8 mm, which is the length of an edge passing by the both resistor elements 4′. The dimension W2 should be 0.6 mm, which is the length of an edge perpendicular to the above-mentioned edge. The pitch interval P2 should be 0.5 mm, which is of two adjacent terminal electrodes 3′.

Further, in order to provide a quad-element chip resistor A4 compliant with 0603 size standard, dimensions of the insulating substrate 1″ are required to be determined as follows. The dimension L4 should be 1.4 mm, which is the length of an edge passing by all the resistor elements 4″. The dimension W4 should be 0.6 mm, which is the length of an edge perpendicular to the above-mentioned edge. The pitch interval P4 should be 0.4 mm, which is of two adjacent terminal electrodes 3″.

Such arranged terminal electrodes 3, 3′, 3″, which are located at the both ends of the resistor elements 4, 4′, 4″ of the chip resistors A1, A2, A4, respectively, are to be mounted and soldered on land patterns formed on a surface of a printed circuit board.

After some manufacturing processes of chip resistors A1, A2, A4 in 0603 size, the dimensions L1, L2, L4, W1, W2, and W4 may be observed with dimensional errors of ±0.1 mm.

Such dimensional errors can be generated due to the manufacturing process where a large material substrate is broken up into a plurality of individual insulating substrates 1, 1′, and 1″.

In consideration of such errors, in the case of mounting a plurality of chip resistors so that all the resistor elements therein are arranged in a straight line, it is necessary to keep a gap of not less than 0.1 mm between every two adjacent chip resistors so as to absorb the dimensional error described above.

In addition, in the case of mounting a plurality of single-element chip resistors A1 parallel one another, on a printed circuit board B are provided a plurality of pairs of land patterns C as shown in FIG. 4, each pair of which corresponds to terminal electrodes 3 at the both end of a resistor element 4 of a single-element chip resistor A1. Usually, the pitch interval P0 of 0.4 mm is provided for every two adjacent lands to enable the single-element chip resistors A1 to be mounted and soldered.

In place of not less than four single-element chip resistors A1 mounted on the printed circuit board B, a plurality of dual-element chip resistors A2 in 0603 size may be optionally employed to be mounted as well as at least one quad-element chip resistor A4.

In the case of employing single-element chip resistors A1 in 0603 size, the insulating substrate 1 has an edge containing a terminal electrode 3 and having the dimension L1 set at L1=0.3 mm, which is smaller than the pitch interval P0=0.4 mm of adjacent land patterns C of the above-described printed circuit board B. As shown in FIG. 5, a plurality of the single-element chip resistors mounted on the land patterns C produce gaps S=0.1 mm, which serve to absorb the dimensional error contained in the dimension L1. The terminal electrodes 3 are thereby located properly on the land patterns C with the overlapping area kept large, facilitating sure soldering.

In the case of employing a quad-element chip resistor A4 in 0603 size instead of not less than four single-element chip resistor A1, the insulating substrate 1″ has the dimension L4=1.4 mm of an edge passing by all the resistor elements 4″, whereas the pitch interval P4=0.4 mm of adjacent resistor elements 4″. As shown in FIG. 6, adjacent quad-element chip resistors mounted on the land patterns C produce a gap S=0.2 mm, which is large enough to form large soldering area and thereby facilitates sure soldering as well as in the case of single-element resistors A1.

In the case of employing several dual-element chip resistors A2 in 0603 size, however, instead of a plurality of single-element chip resistor A1 or a quad-element chip resistor A4, to mount on not less than four land patterns C of the printed circuit board B described above, some disadvantages rise as follows.

The insulating substrate 1′ has the dimension L2=0.8 mm of an edge passing by both of the resistor elements 4′ whereas the pitch interval P2=0.5 mm of adjacent resistor elements 4′. As shown in FIG. 7, with the terminal electrodes 3′ being put on the land pattern C so that they form as a large overlapping area as possible, adjacent dual-element chip resistors A2 mounted on the land patterns C contact with each other and then produce no gap.

As a result, it is impossible to mount properly a plurality of dual-element chip resistors on the common land patterns C which can be used for single-element chip resistors A1 and quad-element chip resistors A4. Thus, employing dual-element resistors requires another design of land patterns only for dual-element chip resistors A2, which cannot be common to land patterns C used for single-element chip resistors A1 and quad-element chip resistors A4.

### SUMMARY OF THE INVENTION

It is an object of the present invention to provide a mounting structure for dual-element chip resistors by which above-described problems are solved.

According to the present invention, there is provided a mounting structure which comprises a printed circuit board and a dual-element chip resistor fixed to the circuit board. Specifically, the chip resistor includes a rectangular insulating substrate and two resistor elements arranged in parallel to each other on the circuit board, each resistor element including a resistor film and terminal electrodes at ends of the resistor film. The circuit board includes a surface provided with at least four land patterns disposed with a predetermined pitch interval. The chip resistor is to be soldered to adjacent two of the four land patterns. The substrate of the chip resistor includes an edge extending in a direction in which the two resistor elements are spaced away from each other, and the edge of the substrate has a length which is smaller than double the pitch interval of the land patterns.

With such a configuration, in the case of employing a plurality of dual-element chip resistors instead of a plurality of single-element chip resistors or quad-element chip resistors, the dual-element chip resistors are mounted in a straight line, therefore causing each two adjacent dual-element chip resistors to form a gap smaller than the double of the pitch interval of land patterns. This produces a large overlapping area of each terminal electrode and a land pattern, that is, a wide soldering area in spite of dimensional errors contained in the dimension of the edge passing by both of the resistor elements. As a result, the dual-element chip resistors are soldered accurately with adequate soldering strength.

Preferably, the pitch interval of the land patterns may be 0.4 mm, while the length of the edge of the substrate may be in a range of 0.6-0.7 mm.

Preferably, the pitch interval between the two resistor elements may be substantially equal to the pitch interval of the land patterns. In this manner, the contact area between each terminal electrode and the corresponding land pattern is increased, which contributes to enhancing the soldering strength.

Preferably, the pitch interval between the two resistor elements may be 0.4 mm.

### BRIEF DESCRIPTION OF THE DRAWINGS

FIG. 1 is a perspective view illustrating a single-element chip resistor.

FIG. 2 is a perspective view illustrating a dual-element chip resistor.

FIG. 3 is a perspective view illustrating a quad-element chip resistor.

FIG. 4 is a perspective view illustrating land patterns of a printed circuit board.

FIG. 5 is a plan view illustrating a mounting configuration of a plurality of single-element chip resistors.

FIG. 6 is a plan view illustrating a mounting configuration of a plurality of quad-element chip resistors.

FIG. 7 is a plan view illustrating a mounting configuration of a plurality of dual-element chip resistors.

FIG. 8 is a perspective view illustrating a dual-element chip resistor according to the present invention.

FIG. 9 is a plan view illustrating a mounted configuration of a plurality of dual-element chip resistors according to the present invention.

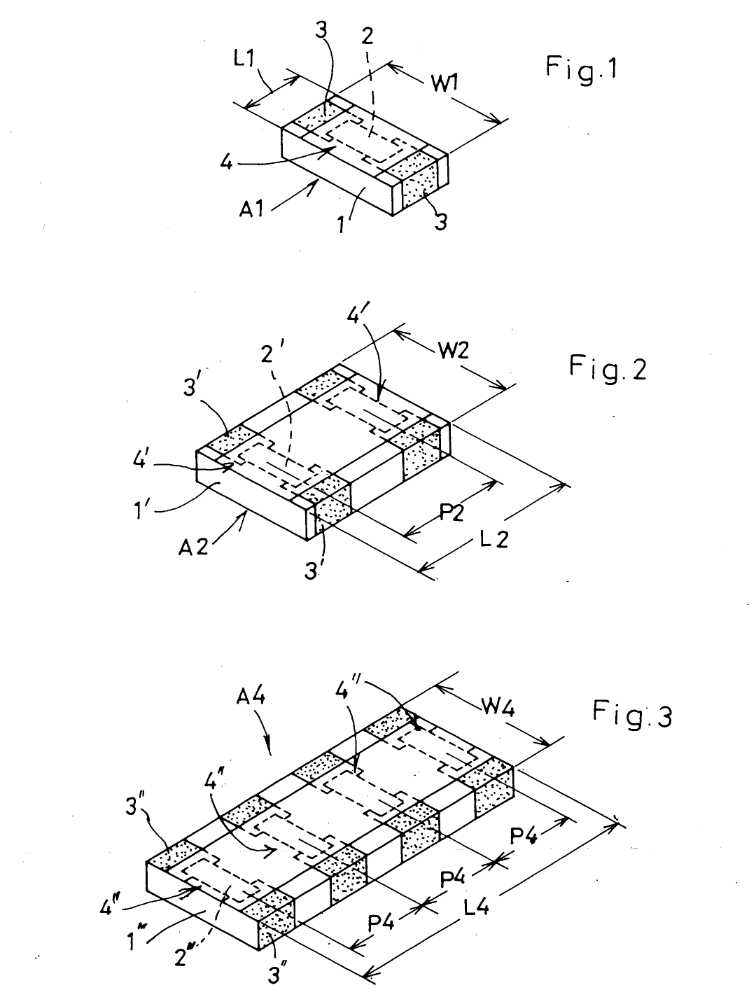

### DETAILED DESCRIPTION OF THE PREFERRED EMBODIMENT

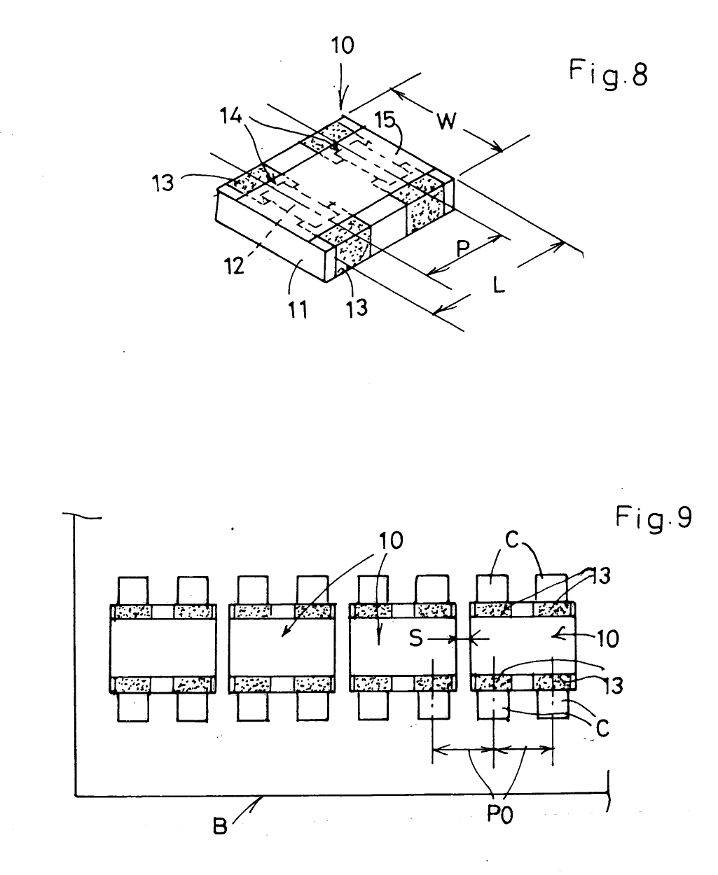

A preferred embodiment of the present invention will be described below with reference to FIGS. 8-9.

FIG. 8 illustrates a dual-element chip resistor 10 according to the present invention.

The dual-element chip resistor 10 comprises single chip-type insulating substrate 11 which is rectangular in plan view, and also comprises two parallel-arranged resistor elements 14 each of which is made of a resistor film 12 formed on the substrate 11, and terminal electrodes 13 at the both ends of the substrate. The chip resistor 10 further comprises a protective film 15 covering the resistor films 12 of the resistor elements 14.

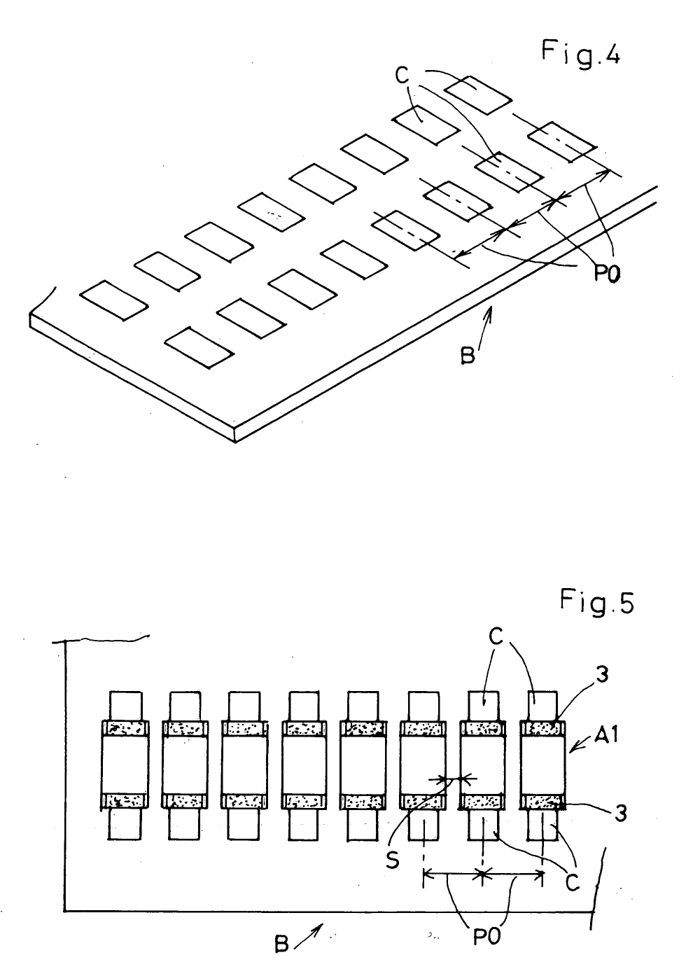

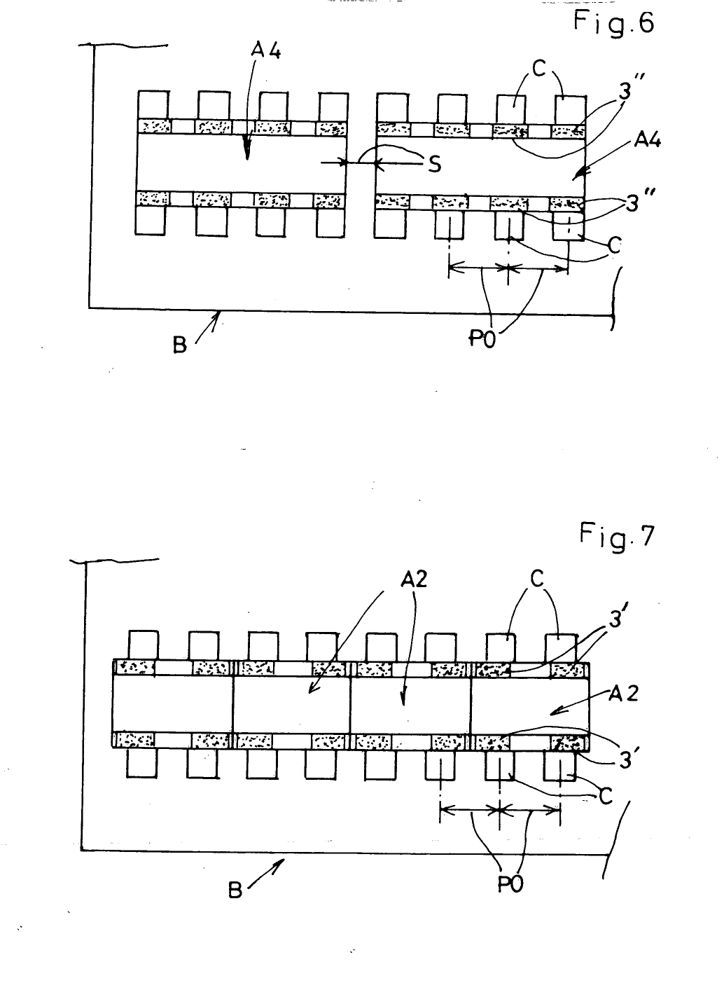

The insulating substrate 11 of the dual-element chip resistor 10 includes edges whose dimensions are determined as follows. The dimension L, which defines the length of an edge passing by both of the resistor elements 14, is set at L=0.7 mm which is 0.1 mm smaller than the double of the pitch interval P0 of the land patterns C constituting the printed circuit board shown in FIG. 4. The dimension W, which defines the length of an edge perpendicular to the above-described edge, is set at W=0.6 mm which is same as in the conventional configuration. The dimension P, which defines the pitch interval of terminal electrodes 13, is set at P=0.4 mm which is substantially equal to the pitch interval P0 of the land patterns C constituting the printed circuit board B.

With such an arrangement, the dual-element chip resistor 10 includes an insulating substrate 11 having the dimension L of an edge, which passes by both of the resistor elements 14, set at 0.7 mm which is less than the double of the pitch interval P0. As shown in FIG. 9, this enables a plurality of the dual-element chip resistors 10 to be mounted on land patterns C, which are formed on the printed circuit board B with a pitch interval P0=0.4 mm, thereby producing gaps S not less than 0.1 mm. Therefore, each terminal electrode 13 of the dual-element chip resistors 10 overlaps a land patterns C with a large area.

In this way, the gaps enable each terminal electrode 13 to overlap a land pattern C with a large area in spite of dimensional error contained in the dimension L, producing large soldering areas.

As a result, a plurality of the dual-element chip resistors 10 arranged in a straight line matches the land patterns C, which are provided on the printed circuit board B and commonly used for mounting a plurality of single-element chip resistors A1 and quad-element chip resistors A4. Therefore, this produces mounting with large soldering areas in place of the single-element chip resistors A1 or the quad-element chip resistors A4.

If the insulating substrate 11 has the dimension L, which defines the length of an edge passing by both of the resistor elements 14, determined more than 0.7 mm, a dimensional error contained in the dimension L reduces the overlapping area of each terminal electrode 13 and a land pattern C.

On the contrary, it is acceptable that the insulating substrate 11 has the dimension L, which defines the length of an edge passing by both of the resistor elements 14, set at not more than 0.7 mm. In this case, however, the dimension L less than 0.6 mm forces the insulating substrate 11 to include a smaller area to form resistor elements 4 on the surface thereof. As a conclusion, the dimension L is most preferably set at 0.6-0.7 mm.

Moreover, the pitch interval P of adjacent resistor elements 14, that is, of adjacent terminal electrode 13 is set at 0.4 mm which is equal to the pitch interval P0 of land patterns C. This enables each terminal electrode 13 to overlap the land patterns C perfectly without shift in the direction of the width, producing large soldering areas and resulting in high soldering strength.

1. A mounting structure which comprises a printed circuit board and a dual-element chip resistor fixed to the circuit board, the chip resistor including a rectangular insulating substrate and two resistor elements arranged in parallel to each other on the circuit board, each resistor element including a resistor film and terminal electrodes at ends of the resistor film, the circuit board including a surface provided with at least four land patterns disposed with a predetermined pitch interval, the chip resistor being soldered to adjacent two of the four land patterns,
wherein the substrate of the chip resistor includes an edge extending in a direction in which the two resistor elements are spaced away from each other, the edge of the substrate having a length which is smaller than double the pitch interval of the land patterns.

2. The mounting structure according to claim 1, wherein a pitch interval between the two resistor elements is substantially equal to the pitch interval of the land patterns.

3. The mounting structure according to claim 1, wherein the pitch interval of the land patterns is 0.4 mm, and the length of the edge of the substrate is in a range of 0.6-0.7 mm.

4. The mounting structure according to claim 3, wherein the pitch interval between the two resistor elements is 0.4 mm.
